(19) United States
(12) Patent Application Publication
(10) Pub. No.: US 2021/0140641 A1
(43) Pub. Date: May 13, 2021

(54) METHOD AND SYSTEM FOR ROTATING DETONATION COMBUSTION

(71) Applicant: General Electric Company, Schenectady, NY (US)

(72) Inventors: Kapil Kumar Singh, Rexford, NY (US); Narendra Digamber Joshi, Schenectady, NY (US)

(21) Appl. No.: 16/682,122

(22) Filed: Nov. 13, 2019

(51) Int. Cl. F23R 3/34; F23R 3/50; F02C 7/22

(52) U.S. Cl. CPC F23R 3/346; F02C 7/22; F23R 3/50

(57) ABSTRACT

A rotating detonation combustion (RDC) assembly and propulsion system, and method for operation, are provided. The RDC assembly includes a detonation path extended from a detonation zone at which a predetonation device is in operative communication with a fuel/oxidizer mixture at a detonation chamber. The method includes generating a first fuel/oxidizer equivalence ratio of detonation gases at a first portion of the detonation path, wherein the first portion of the detonation path is defined along a first direction from the detonation zone along which a detonation wave propagates; generating a second fuel/oxidizer equivalence ratio of detonation gases at the second portion of the detonation path, wherein the second fuel/oxidizer equivalence ratio is different from the first fuel/oxidizer equivalence ratio, and wherein the second portion of the detonation path is defined from the first portion to the predetonation device; and sustaining the detonation wave via the second fuel/oxidizer equivalence ratio of detonation gases at the second portion of the detonation path.

### FIELD

The present subject matter relates generally to a system of continuous detonation in a propulsion system.

### BACKGROUND

Many propulsion systems, such as gas turbine engines, are based on the Brayton Cycle, where air is compressed adiabatically, heat is added at constant pressure, the resulting hot gas is expanded in a turbine, and heat is rejected at constant pressure. The energy above that required to drive the compression system is then available for propulsion or other work. Such propulsion systems generally rely upon deflagrative combustion to burn a fuel/air mixture and produce combustion gas products which travel at relatively slow rates and constant pressure within a combustion chamber. While engines based on the Brayton Cycle have reached a high level of thermodynamic efficiency by steady improvements in component efficiencies and increases in pressure ratio and peak temperature, further improvements are welcomed nonetheless.

Accordingly, improvements in engine efficiency have been sought by modifying the engine architecture such that the combustion occurs as a detonation in a continuous mode. High energy ignition detonates a fuel/air mixture that transitions into a detonation wave (i.e., a fast moving shock wave closely coupled to the reaction zone). The detonation wave travels in a Mach number range greater than the speed of sound with respect to the speed of sound of the reactants. The products of combustion follow the detonation wave at the speed of sound and at significantly elevated pressure. Such combustion products may then exit through a nozzle to produce thrust or rotate a turbine.

However, continuous detonation systems are challenged to sustain detonation in general, or to sustain detonation across various operating conditions. Without sustaining detonation of the fuel/air mixture, detonation combustion systems may be insufficiently operable for use in gas turbine engines. As such, there is a need for methods and systems for sustaining detonation of fuel/air mixture in a detonation combustion system.

### BRIEF DESCRIPTION

Aspects and advantages of the invention will be set forth in part in the following description, or may be obvious from the description, or may be learned through practice of the invention.

An aspect of the present disclosure is directed to a method for operating a rotating detonation combustion (RDC) assembly. The RDC assembly includes a detonation path extended from a detonation zone at which a predetonation device is in operative communication with a fuel/oxidizer mixture at a detonation chamber. The method includes generating a first fuel/oxidizer equivalence ratio of detonation gases at a first portion of the detonation path, wherein the first portion of the detonation path is defined along a first direction from the detonation zone along which a detonation wave propagates; generating a second fuel/oxidizer equivalence ratio of detonation gases at the second portion of the detonation path, wherein the second fuel/oxidizer equivalence ratio is different from the first fuel/oxidizer equivalence ratio, and wherein the second portion of the detonation path different from the first portion of the detonation path is defined between the first portion and the predetonation device; and sustaining the detonation wave via the second fuel/oxidizer equivalence ratio of detonation gases at the second portion of the detonation path.

Another aspect of the present disclosure is directed to a rotating detonation combustion (RDC) assembly including a detonation chamber extended around a centerline axis, wherein the detonation chamber defines a detonation path; a predetonation device extended to the detonation chamber in operative communication with a fuel/oxidizer mixture at the detonation chamber, in which the predetonation device defines a detonation zone at the detonation path at which the predetonation device generates a detonation wave of the fuel/oxidizer mixture at the detonation chamber, and a first portion of the detonation path is defined along a first direction from the detonation zone along which the detonation wave propagates, and a second portion of the detonation path different from the first portion of the detonation path is defined along a second direction opposite of the first direction between the predetonation device and the first portion of the detonation path. The RDC assembly further includes a plurality of fuel injectors positioned in adjacent arrangement around a centerline axis, in which the plurality of fuel injectors is in fluid communication with the detonation path. The plurality of fuel injectors include a first fuel injector configured to generate a first fuel/oxidizer mixture at the first portion of the detonation path; and a second fuel injector configured to generate a second fuel/oxidizer mixture at the second portion of the detonation path, wherein the second fuel/oxidizer mixture is different from the first fuel/oxidizer mixture.

Yet another aspect of the present disclosure is directed to a propulsion system for a hypersonic vehicle. The propulsion system includes a rotating detonation combustion (RDC) assembly including a detonation chamber extended around a centerline axis, wherein the detonation chamber defines a detonation path; a predetonation device extended to the detonation chamber, wherein the predetonation device defines a detonation zone at the detonation path at which the predetonation device generates a detonation wave of detonation gases at the detonation chamber, and wherein a first portion of the detonation path is defined along a first direction from the detonation zone along which the detonation wave propagates, and further wherein a second portion of the detonation path different from the first portion of the detonation path is defined between the predetonation device and the first portion of the detonation path; and a plurality of fuel injectors positioned in adjacent arrangement around a centerline axis, wherein the plurality of fuel injectors is in fluid communication with the detonation path. The plurality of fuel injectors includes a first fuel injector configured to generate a first fuel/oxidizer mixture at the first portion of the detonation path; and a second fuel injector configured to generate a second fuel/oxidizer mixture at the second portion of the detonation path, wherein the second fuel/oxidizer mixture is different from the first fuel/oxidizer mixture. The propulsion system further includes a controller configured to execute instructions. The instructions include generating, via the first fuel/oxidizer mixture, a first fuel/oxidizer equivalence ratio of detonation gases at the first portion of the detonation path; and generating, via the second fuel/oxidizer mixture, a second fuel/oxidizer equivalence ratio of detonation gases at the second portion of the detonation path, wherein the second fuel/oxidizer equivalence ratio is different from the first fuel/oxidizer equivalence ratio.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a schematic view of a heat engine including a rotating detonation combustion system in accordance with an exemplary embodiment of the present disclosure;

FIG. 2 is a schematic view of an exemplary embodiment of a rotating detonation combustion system according to an aspect of the present disclosure;

FIG. 3A is a perspective view of a detonation chamber of the exemplary rotating detonation combustion system of FIG. 2;

FIG. 3B is a perspective view of a detonation chamber of the exemplary rotating detonation combustion system of FIG. 2;

FIG. 4 is a downstream viewed upstream flow path view of an exemplary embodiment of the rotating detonation combustion system according to aspects of the present disclosure;

FIG. 5 is a downstream viewed upstream flowpath view of an exemplary embodiment of the rotating detonation combustion system according to aspects of the present disclosure;

FIG. 6 is a flowchart outlining exemplary steps of a method for sustaining rotating detonation combustion;

FIG. 7 is an exemplary embodiment of a vehicle including a rotating detonation combustion system according to an aspect of the present disclosure; and

FIG. 8 is an exemplary embodiment of a propulsion system including a rotating detonation combustion system according to an aspect of the present disclosure.

Repeat use of reference characters in the present specification and drawings is intended to represent the same or analogous features or elements of the present invention.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first”, “second”, and “third” may be used interchangeably to distinguish one component from another and are not intended to signify location or importance of the individual components.

The terms “forward” and “aft” refer to relative positions within a propulsion system or vehicle, and refer to the normal operational attitude of the propulsion system or vehicle. For example, with regard to a propulsion system, forward refers to a position closer to a propulsion system inlet and aft refers to a position closer to a propulsion system nozzle or exhaust.

The terms “upstream” and “downstream” refer to the relative direction with respect to fluid flow in a fluid pathway. For example, “upstream” refers to the direction from which the fluid flows, and “downstream” refers to the direction to which the fluid flows.

The singular forms “a”, “an”, and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

The term or phrase “equivalence ratio” refers at least to a ratio of an actual fuel/oxidizer ratio to a stoichiometric fuel/oxidizer ratio. In various instances, “actual fuel/oxidizer ratio” refers to a fuel/oxidizer mixture provided from one or more fuel injectors. In still various instances, “stoichiometric fuel/oxidizer ratio” refers to an ideal ratio of fuel and oxidizer to burn all of the fuel without excess oxidizer in the burned or detonated gases. However, it should be appreciated that in various embodiments, a fuel/oxidizer equivalence ratio referred to herein may be converted to an oxidizer/fuel equivalence ratio, a fuel/oxidizer ratio based on mass, a fuel/oxidizer ratio based on moles, or other units conversion without deviating from the present disclosure.

Embodiments of a rotating detonation combustion (RDC) system and method for operating an RDC system are provided herein. Embodiments of the systems and methods provided herein may sustain detonation of a fuel/oxidizer mixture across a plurality of steady-state and transient inlet conditions. Sustaining detonation of the fuel/oxidizer mixture, such as to mitigate or eliminate loss of detonation through the detonation chamber, may provide RDC systems and methods for operation across a desired operability and/or performance envelope for a heat engine, such as propulsion systems for hypersonic vehicles.

Referring now to the figures, FIG. 1 depicts a heat engine or propulsion system including a rotating detonation combustion system 100 (an “RDC system 100”) in accordance with an exemplary embodiment of the present disclosure. For the embodiment of FIG. 1, the engine is generally configured as a heat engine 102. More specifically, the heat engine 102 generally includes an inlet or compressor section 104 and an outlet or turbine section 106. In various embodiments, the RDC system 100 is positioned downstream of the compressor section 104. In some embodiments, such as depicted in regard to FIG. 1, the RDC system 100 is positioned upstream of the turbine section 106. In other embodiments, such as further shown and described in regard to FIG. 8, the RDC system 100 is positioned upstream and/or downstream of the turbine section 106. During operation, a flow of air or oxidizer 81 may be provided to an inlet 108 of the compressor section 104, wherein such oxidizer flow is compressed through one or more compressors, each of which may include one or more alternating stages of compressor rotor blades and compressor stator vanes. However, in various embodiments, the compressor section 104 may define a nozzle through which the airflow is compressed as it flows to the RDC system 100.

As will be discussed in greater detail below, compressed oxidizer 82 from the compressor section 104 may then be provided to the RDC system 100, wherein the compressed oxidizer 82 may be mixed with a liquid and/or gaseous fuel 83 to form a fuel/oxidizer mixture 132 that is then detonated to generate combustion products 138. The combustion products 138 may then flow to the turbine section 106 wherein one or more turbines may extract kinetic/rotational energy from the combustion products. As with the compressor(s) within the compressor section 104, each of the turbine(s) within the turbine section 106 may include one or more alternating stages of turbine rotor blades and turbine stator vanes. However, in various embodiments, the turbine section 106 may define an expansion section through which detonation gases are expanded and provide propulsive thrust from the RDC system 100. In still various embodiments, the combustion gases or products may then flow from the turbine section 106 through, e.g., an exhaust nozzle to generate thrust for the heat engine 102.

As will be appreciated, rotation of the turbine(s) within the turbine section 106, generated by the combustion products, is transferred through one or more shafts or spools 110 to drive the compressor(s) within the compressor section 104. In various embodiments, the compressor section 104 may further define a fan section, such as for a turbofan engine configuration, such as to propel air across a bypass flowpath outside of the RDC system 100 and turbine section 106.

It will be appreciated that the heat engine 102 depicted schematically in FIG. 1 is provided by way of example only. In certain exemplary embodiments, the heat engine 102 may include any suitable number of compressors within the compressor section 104, any suitable number of turbines within the turbine section 106, and further may include any number of shafts or spools 110 appropriate for mechanically linking the compressor(s), turbine(s), and/or fans. Similarly, in other exemplary embodiments, the heat engine 102 may include any suitable fan section, with a fan thereof being driven by the turbine section 106 in any suitable manner. For example, in certain embodiments, the fan may be directly linked to a turbine within the turbine section 106, or alternatively, may be driven by a turbine within the turbine section 106 across a reduction gearbox. Additionally, the fan may be a variable pitch fan, a fixed pitch fan, a ducted fan (i.e., the heat engine 102 may include an outer nacelle surrounding the fan section), an un-ducted fan, or may have any other suitable configuration.

Moreover, it should also be appreciated that the RDC system 100 may further be incorporated into any other suitable aeronautical propulsion system, such as a hypersonic propulsion system, a turbofan engine, a turboshaft engine, a turboprop engine, a turbojet engine, a ramjet engine, a scramjet engine, etc., or combinations thereof, such as combined-cycle propulsion systems. Further, in certain embodiments, the RDC system 100 may be incorporated into a non-aeronautical propulsion system, such as a land-based power-generating propulsion system, an aero-derivative propulsion system, etc. Further, still, in certain embodiments, the RDC system 100 may be incorporated into any other suitable propulsion system or vehicle, such as a manned or unmanned aircraft, a rocket, missile, a launch vehicle, etc. With one or more of the latter embodiments, the propulsion system may not include a compressor section 104 or a turbine section 106, and instead may simply include a convergent and/or divergent flowpath leading to and from, respectively, the RDC system 100. For example, the turbine section 106 may generally define the nozzle through which the combustion products flowing therethrough to generate thrust.

Referring now to FIG. 2, a side, schematic view is provided of an exemplary RDC system 100 as may be incorporated into the exemplary embodiment of FIG. 1. As shown, the RDC system 100 generally defines a longitudinal centerline axis 116 that may be common to the heat engine 102, a radial direction R relative to the longitudinal centerline axis 116, and a circumferential direction C relative to the longitudinal centerline axis 116 (see, e.g., FIGS. 3-4), and a longitudinal direction L (shown in FIG. 1).

The RDC system 100 generally includes an outer wall 118 and an inner wall 120 spaced from one another along the radial direction R. The outer wall 118 and the inner wall 120 together define in part a detonation chamber 122, a detonation chamber inlet 124, and a detonation chamber outlet 126. The detonation chamber 122 defines a detonation chamber length 123 along the longitudinal centerline axis 116.

Further, the RDC system 100 includes a plurality of fuel injectors 128 located at the detonation chamber inlet 124. The fuel injector 128 provides at least a flow of fuel 83 to the detonation chamber 122. In certain embodiments, the fuel injector 128 is extended substantially radially through the inner wall 118 and/or the outer wall 120 to provide a substantially radial flow of fuel 83. In still certain embodiments, the fuel injector 128 is extended axially to provide a substantially axial flow of fuel 83. In certain embodiments, the fuel injector 128 provides a flow mixture of fuel and oxidizer. The flow of fuel 83 is mixed with the compressed air or oxidizer 82 to generate the fuel/oxidizer mixture 132. The mixture 132 is combusted or detonated to generate the combustion products 138, and more specifically a detonation wave 130 as will be explained in greater detail below. The combustion products 138 exit through the detonation chamber outlet 126, such as to the turbine section 106 or exhaust nozzle such as described in regard to FIG. 1. Although the detonation chamber 122 is depicted as a single detonation chamber, in other exemplary embodiments of the present disclosure, the RDC system 100 may include multiple detonation chambers defined at least by multiple outer walls and inner walls.

In one embodiment, such as depicted in FIG. 4, the outer wall 118 and the inner wall 120 are each generally annular and generally concentric around the longitudinal centerline axis 116. In another embodiment, such as depicted in FIG. 5, the outer wall 118 and the inner wall 120 are in two-dimensional relationship relative to the centerline axis 116, such as to define a width and a height, or alternatively, a variable distance 115 relative to an angle 114, from the centerline axis 116. The outer wall 118 and the inner wall 120 together define a detonation path (e.g., detonation path 410 in FIGS. 4-5) within the detonation chamber 122. The RDC system 100 includes a plurality of fuel injectors 128 in adjacent arrangement to one another around the centerline axis 116. In regard to FIG. 4, the plurality of fuel injectors 128 is positioned in circumferential arrangement next to one another relative to the centerline axis 116. In regard to FIG. 5, the plurality of fuel injectors 128 is positioned along the two-dimensional flowpath arrangement relative to the centerline axis 116.

It should be appreciated that the plurality of fuel injectors 128 depicted in regard to FIGS. 4-5 may generally represent circumferential or two-dimensional positioning of the fuel injectors relative to the gas flowpath. As such, the plurality of fuel injectors 128 depicted in FIGS. 4-5 may be positioned to provide a substantially radial in-flow of fuel or a substantially axial in-flow of fuel, such as depicted in regard to FIG. 2 or FIGS. 3A-3B.

Referring briefly to FIGS. 3A-3B, which provides a perspective view of the detonation chamber 122, it will be appreciated that the RDC system 100 generates the detonation wave 130 during operation. The detonation wave 130 travels in the circumferential direction C of the RDC system 100 consuming an incoming fuel/oxidizer mixture 132 and providing a high pressure region 134 within an expansion region 136 of the combustion. A burned fuel/oxidizer mixture 138 (i.e., detonation gases) exits the detonation chamber 122 and is exhausted.

More particularly, it will be appreciated that the RDC system 100 is of a detonation-type combustor, deriving energy from the continuous wave 130 of detonation. For a detonation combustor, such as the RDC system 100 disclosed herein, the combustion of the fuel/oxidizer mixture 132 is effectively a detonation as compared to a burning, as is typical in the traditional deflagration-type combustors. Accordingly, a main difference between deflagration and detonation is linked to the mechanism of flame propagation. In deflagration, the flame propagation is a function of the heat transfer from a reactive zone to the fresh mixture, generally through conduction. By contrast, with a detonation combustor, the detonation is a shock induced flame, which results in the coupling of a reaction zone and a shockwave. The shockwave compresses and heats the fresh mixture 132, increasing such mixture 132 above a self-ignition point. On the other side, energy released by the detonation contributes to the propagation of the detonation shockwave 130. Further, with continuous detonation, the detonation wave 130 propagates around the detonation chamber 122 in a continuous manner, operating at a relatively high frequency. Additionally, the detonation wave 130 may be such that an average pressure inside the detonation chamber 122 is higher than an average pressure within typical combustion systems (i.e., deflagration combustion systems).

Accordingly, the region 134 behind the detonation wave 130 has very high pressures. As will be appreciated from the discussion below, the fuel injector 128 of the RDC system 100 is designed to prevent the high pressures within the region 134 behind the detonation wave 130 from flowing in an upstream direction, i.e., into the incoming flow of the fuel/oxidizer mixture 132.

Referring now to FIGS. 4-5, flowpath views of the RDC system 100 are provided from downstream viewing upstream toward the plurality of fuel injectors 128. Referring to FIGS. 3-5, the RDC system 100 includes the detonation chamber 122 extended around the longitudinal centerline axis 116. The detonation path 410 is defined around the centerline axis 116, such as along the circumferential direction C. The detonation path 410 further extends along the detonation chamber length 123 (FIG. 2).

A predetonation device 420 is extended to the detonation chamber 122 in operative communication with a fuel/oxidizer mixture 132 at the detonation chamber 122, such as depicted at FIGS. 3A-3B. In various embodiments, the predetonation device 420 includes an ignition source or other apparatus providing energy for detonating the fuel/oxidizer mixture 132 or releasing a detonation wave in the detonation path 410. In particular embodiments, the predetonation device 420 is extended substantially tangentially to the detonation path 410. The predetonation device 420 defines a predetonation zone 422 tangentially proximate to the predetonation device 420 at the detonation path 410. The predetonation device 420 generates the detonation wave 130 of the fuel/oxidizer mixture 132 at the detonation chamber 122, such as depicted in regard to FIGS. 3A-3B. The detonation wave 130 propagates along the first direction 91 from the predetonation zone 422. A first portion 412 of the detonation path 410 is defined along a first direction 91 from the predetonation zone 422. The detonation wave 130 propagates through the first portion 412 of the detonation path 410 along the first direction 91. For example, the detonation wave 130 may initially be generated at the first portion 412 of the detonation path 410 and subsequently propagate along the first direction 91 through the first portion 412 of the detonation path 410.

The detonation path 410 further defines a second portion 414 different from the first portion 412 of the detonation path 410. The second portion 414 is defined between the predetonation device 420 and the first portion 412 of the detonation path 410. For example, a second direction 92 extended opposite of the first direction 91 is defined from the predetonation device 420. The second portion 414 of the detonation path 410 is defined along the second direction 92 and between the first portion 412 and the predetonation device 420. As another example, the second portion 414 is defined along the first direction 91 between the first portion 412 and the predetonation device 420. In still another example, the second portion 414 is defined sequentially along the first direction 91 between the first portion 412 and the predetonation device 420. In various embodiments, the second portion 414 of the detonation path 410 corresponds to between 1% and 25% of the detonation path 410, and the first portion 412 corresponds to the substantial remainder of the detonation path 410 (i.e., between 99% and 75% of the detonation path 410). In one embodiment, the second portion 414 of the detonation path 410 corresponds to between 4% and 20% of the detonation path 410, and the first portion 412 corresponds to the substantial remainder of the detonation path 410 (i.e., between 96% and 80% of the detonation path 410). In another embodiment, the second portion 414 of the detonation path 410 corresponds to between 10% and 20% of the detonation path 410, and the first portion 412 corresponds to the substantial remainder of the detonation path 410 (i.e., between 90% and 80% of the detonation path 410).

The plurality of fuel injectors 128 is in fluid communication with the detonation path 410 such as described above. The plurality of fuel injectors 128 further includes a first fuel injector 228 corresponding to the first portion 412 of the detonation path 410 and a second fuel injector 328 corresponding to the second portion 414 of the detonation path. The first fuel injector 228 is configured to generate a first fuel/oxidizer mixture at the first portion 412 of the detonation path 410. The second fuel injector 328 is configured to generate a second fuel/oxidizer mixture at the second portion 414 of the detonation path 410 different from the first fuel/oxidizer mixture.

For example, the plurality of fuel injectors 128 includes one or more first fuel injectors 228 positioned in fluid communication with the detonation path 410 in which the first fuel injector 228 provides the first fuel/oxidizer mixture at the first portion 412 of the detonation path 410. Furthermore, the plurality of fuel injectors 128 includes one or more second fuel injectors 328 positioned in fluid communication with the detonation path 410 in which the second fuel injector 328 provides the second fuel/oxidizer mixture to the second portion 414 of the detonation path 410.

In various embodiments, the first fuel injector 228 includes a first geometry 226 corresponding to one or more of a cross sectional area or volume different from the second fuel injector including a second geometry 326 corresponding to one or more of a cross sectional area of volume different from the first geometry 226. In one embodiment, the different geometries 226, 326 of the first fuel injector 228 and second fuel injector 328 relative to one another are configured to provide different flow rates, pressures, temperatures, or other characteristics providing different fuel/oxidizer mixtures. In other embodiments, the fuel injectors 228, 328 may additionally, or alternatively, be connected to fuel systems configured to provide different fuel flow rates, fuel pressures, fuel temperatures, or other characteristics providing different fuel/oxidizer mixtures from respective first and second fuel injectors 228, 328.

Detonation and burn of the first fuel/oxidizer mixture from the first fuel injector 228 corresponds to a lower fuel/oxidizer equivalence ratio burn in contrast to burn of the second fuel/oxidizer mixture from the second fuel injector 328. The second fuel injector 328 defines a richer burning fuel injector relative to the first fuel injector 228. Stated differently, during operation of the RDC system 100, the detonation gases corresponding to detonation and burn of the first fuel/oxidizer mixture at the first portion 412 define a first fuel/oxidizer equivalence ratio of detonation gases defining a lower fuel/oxidizer equivalence ratio than the detonation gases produced at the second portion 414 corresponding to a second fuel/oxidizer equivalence ratio of detonation gases. The equivalence ratio may be defined as a ratio of actual fuel/oxidizer ratio over stoichiometric fuel/oxidizer ratio.

In one embodiment, the first fuel injector 228 produces a leaner burn of detonation gases via the first fuel/oxidizer mixture at the first portion 412 than the detonation gases produced via the second fuel/oxidizer mixture at the second portion 414 of the detonation path. In another embodiment, the second fuel injector 328 produces a richer burn of detonation gases via the second fuel/oxidizer mixture at the second portion 414 than the detonation gases produced via the first fuel/oxidizer mixture at the first portion 412 of the detonation path 410.

In various embodiments, the first fuel/oxidizer equivalence ratio defines a lean burn from the first fuel/oxidizer mixture and the second fuel/oxidizer equivalence ratio from the second fuel/oxidizer mixture defines a less lean or richer burn than the first fuel/oxidizer equivalence ratio. In one embodiment, the first fuel/oxidizer equivalence ratio is lean (i.e., the first fuel/oxidizer equivalence ratio is less than 1) and the second fuel/oxidizer equivalence ratio is richer than the first fuel/oxidizer equivalence ratio (i.e., the second fuel/oxidizer equivalence is greater than the first fuel/oxidizer equivalence ratio). In another embodiment, the first fuel/oxidizer equivalence ratio is lean and the second fuel/oxidizer equivalence ratio is rich (i.e., the second fuel/oxidizer equivalence ratio is greater than 1).

In still various embodiments, the second fuel/oxidizer equivalence ratio defines a rich burn from the first fuel/oxidizer mixture and the second fuel/oxidizer equivalence ratio from the second fuel/oxidizer mixture defines a less rich or leaner burn than the second fuel/oxidizer equivalence ratio. In one embodiment, the second fuel/oxidizer equivalence ratio is rich and the first fuel/oxidizer equivalence ratio is leaner than the second fuel/oxidizer equivalence ratio (i.e., the first fuel/oxidizer equivalence ratio is less than the second fuel/oxidizer equivalence ratio). In another embodiment, the second fuel/oxidizer equivalence ratio is rich and the first fuel/oxidizer equivalence ratio is lean (i.e., the first fuel/oxidizer equivalence ratio less than 1).

As such, in various embodiments, the first fuel injector 228 may be configured to produce the first fuel/oxidizer equivalence ratio that is less than the second fuel/oxidizer equivalence ratio, such that the first fuel/oxidizer equivalence ratio may be rich, lean, or stoichiometric, and leaner or less rich than the second fuel/oxidizer equivalence ratio. Alternatively, second fuel injector 328 may be configured to produce the second fuel/oxidizer equivalence ratio that is greater than the first fuel/oxidizer equivalence ratio, such that the second fuel/oxidizer equivalence ratio may be rich, lean or stoichiometric, and more rich than the first fuel/oxidizer equivalence ratio.

Referring back to FIG. 1, in conjunction with FIGS. 2-5, the RDC system 100 further includes a controller configured to adjust, modulate, or otherwise provide fuel/oxidizer mixtures and equivalence ratios such as described herein. In general, the controller 210 can correspond to any suitable processor-based device, including one or more computing devices. For instance, FIG. 1 illustrates one embodiment of suitable components that can be included within the controller 210. As shown in FIG. 1, the controller 210 can include a processor 212 and associated memory 214 configured to perform a variety of computer-implemented functions (e.g., performing the methods, steps, calculations and the like disclosed herein). As used herein, the term “processor” refers not only to integrated circuits referred to in the art as being included in a computer, but also refers to a controller, microcontroller, a microcomputer, a programmable logic controller (PLC), an application specific integrated circuit (ASIC), a Field Programmable Gate Array (FPGA), and other programmable circuits. Additionally, the memory 214 can generally include memory element(s) including, but not limited to, computer readable medium (e.g., random access memory (RAM)), computer readable non-volatile medium (e.g., flash memory), a compact disc-read only memory (CD-ROM), a magneto-optical disk (MOD), a digital versatile disc (DVD) and/or other suitable memory elements or combinations thereof. In various embodiments, the controller 210 may define one or more of a full authority digital engine controller (FADEC), a propeller control unit (PCU), an engine control unit (ECU), or an electronic engine control (EEC).

As shown, the controller 210 can include control logic 216 stored in memory 214. The control logic 216 may include instructions that when executed by the one or more processors 212 cause the one or more processors 212 to perform operations, such as steps of a method 1000 for sustaining rotating detonation combustion as outlined and described in regard to FIG. 6.

Additionally, as shown in FIG. 1, the controller 210 can also include a communications interface module 230. In several embodiments, the communications interface module 230 can include associated electronic circuitry that is used to send and receive data. As such, the communications interface module 230 of the controller 210 can be used to send and/or receive data to/from engine 102 and the RDC system 100. In addition, the communications interface module 230 can also be used to communicate with any other suitable components of the engine 102, including any number of sensors, valves, flow control devices, orifices, etc. configured to determine, calculate, modify, alternate, articulate, adjust, or otherwise provide a desired fuel characteristic and/or oxidizer characteristic to the detonation chamber 122, including, but not limited to, fluid flow rate, fluid pressure, fluid temperature, fluid density, fluid atomization, etc. It should be appreciated that the communications interface module 230 can be any combination of suitable wired and/or wireless communications interfaces and, thus, can be communicatively coupled to one or more components of the RDC system 100 and engine 102 via a wired and/or wireless connection. As such, the controller 210 may obtain, determine, store, generate, transmit, or operate any one or more steps of the method 1000 at the engine 102, an apparatus to which the engine 102 is attached (e.g., an aircraft), or a ground, air, or satellite-based apparatus in communication with the engine 102 (e.g., a distributed network).

Referring now to FIG. 6, an exemplary outline of a method 1000 for operating a rotating detonation combustion (RDC) system, and sustaining rotating detonation combustion, is provided (hereinafter, “method 1000”). The method 1000 may be performed with any suitable rotating detonation combustion system of any suitable engine, such as one or more embodiments of the RDC system 100 provided herein and/or one or more embodiments of the engine 102 provided herein. As discussed above, one or more steps of the method 1000 may be stored and/or executed via one or more embodiments of the controller 210 described herein.

The method 1000 includes at 1010 generating a first fuel/oxidizer equivalence ratio of detonation gases at a first portion of a detonation path, such as via the first fuel/oxidizer mixture, such as shown and described in regard to FIGS. 1-4. The method 1000 includes at 1020 generating a second fuel/oxidizer equivalence ratio of detonation gases at the second portion of the detonation path, via the second fuel/oxidizer mixture, such as shown and described in regard to FIGS. 1-4. The method 1000 may further include at 1030 sustaining the detonation wave via the second fuel/oxidizer equivalence ratio of detonation gases at the second portion of the detonation path. In some embodiments, sustaining the detonation wave at 1030 further includes sustaining the detonation wave via the second fuel/oxidizer mixture corresponding to a richer burn of the second fuel/oxidizer mixture relative to the first fuel/oxidizer mixture.

In various embodiments, the first fuel/oxidizer equivalence ratio of detonation gases defines a lower equivalence ratio than the second fuel/oxidizer equivalence ratio of detonation gases. In one embodiment, generating the second fuel/oxidizer equivalence ratio of detonation gases corresponds to rich burn of the second fuel/oxidizer mixture. In another embodiment, generating the first fuel/oxidizer equivalence ratio of detonation gases corresponds to lean burn of the first fuel/oxidizer mixture. In still various embodiments, generating the second fuel/oxidizer equivalence ratio of detonation gases at the second portion of the detonation path corresponds to generating the second fuel/oxidizer equivalence ratio of detonation gases between 1% and 25% of the detonation path. In various embodiments, the portion of the detonation path at which the second fuel/oxidizer equivalence ratio of detonation gases is generated corresponds to the second portion 414 of the detonation path 410 such as further described herein.

It should be appreciated that generating the first or second fuel/oxidizer equivalence ratio of detonation gases may correspond to the first fuel injector 228 and the second fuel injector 328, respectively, arranged, provided, or distributed such as shown and described in regard to FIGS. 1-5. In certain embodiments of the method 1000, generating the first fuel/oxidizer equivalence ratio of detonation gases at a first portion (e.g., first portion 412 in FIGS. 4-5) of a detonation path (e.g., detonation path 410 in FIGS. 4-5) includes providing a leaner burn of the first fuel/oxidizer mixture from a first fuel injector (e.g., first fuel injector 228 in FIGS. 4-5) in contrast to the second fuel/oxidizer equivalence ratio of detonation gases generated at a second portion (e.g., second portion 414 in FIGS. 4-5) of the detonation path. In still certain embodiments of the method 1000, generating the second fuel/oxidizer equivalence ratio of detonation gases at the second portion (e.g., second portion 414 in FIGS. 4-5) of the detonation path (e.g., detonation path 410 in FIGS. 4-5) includes providing a richer burn of the second fuel/oxidizer mixture from a second fuel injector (e.g., second fuel injector 328 in FIGS. 4-5) in contrast to the first fuel/oxidizer equivalence ratio of detonation gases generated at a first portion (e.g., first portion 414 in FIGS. 4-5) of the detonation path.

In various embodiments, such as shown and described in regard to FIGS. 4-5, the first portion 412 of the detonation path 410 corresponds to approximately 75% to 99% of the detonation path 410 and the second portion 414 of the detonation path corresponds to the remainder of the detonation path (i.e., approximately 25% to 1% of the detonation path 410). In certain embodiments, the first portion 412 corresponds to approximately 75% to 99% of a perimetric or annular area of the detonation path 410 and the second portion 414 corresponds to the remainder of the detonation path 410.

It should further be appreciated that the first portion 412 may define or correspond to a sequential or consecutive arrangement of the first fuel injectors 228 and the second portion 414 may define or correspond to a sequential or consecutive arrangement of the second fuel injectors 328. Therefore, a sequential or consecutive arrangement of the first fuel injector 228 may correspond to between 75% to 99% of the fuel injectors 128 and a sequential or consecutive arrangement of the second fuel injectors 328 may correspond to approximately 25% to 1% of the fuel injectors 128. Still further, in various embodiments, the arrangement of the first fuel injectors 228 and the second fuel injectors 328 may be defined relative to the predetonation device 420, such as shown and described herein in regard to FIGS. 1-5.

In various embodiments, sustaining the detonation wave (e.g., detonation wave 130 in FIGS. 3A-3B) refers to providing an operation in detonation mode of the RDC system 100 over a wider range and relatively better quality over other detonation combustion systems. The sustained detonation wave may provide for wider operating ranges, such as greater ranges of fuel and/or oxidizer inputs, pressure ranges, inlet temperatures, or other fluid characteristics corresponding to an operating mode of the RDC system 100 and/or heat engine 102, or a vehicle attached thereto.

Embodiments of the system 100 and method 1000 shown and described herein may provide one or more improvements over known detonation combustion systems and methods for operation. In various embodiments, the RDC system 100 and/or method 1000 for operation may provide asymmetric fuel injection (i.e., fuel/oxidizer mixtures to the respective first portion 412 and the second portion 414 of the detonation path 410) into a symmetric, annular, or two-dimensional detonation path. A relatively richer fuel/oxidizer mixture to a predetonation entry zone (i.e., the second portion 414) may increase, widen, or otherwise improve a range of operation of an RDC system. In certain embodiments, the richer fuel/oxidizer mixture to the second portion 414 in contrast to the first portion 412 of the detonation path 410 may provide sustained detonation waves. In still various embodiments, one or more of the ranges or ratios of the first portion 412 versus the second portion 414 as shown and described herein provide an unexpected benefit of sustaining detonation waves at an RDC system.

The sustained detonation waves may improve an operating range of an RDC system and/or a vehicle including the RDC system (e.g., an engine 200, aircraft 700, or other propulsion system or vehicle such as further described herein). Sustaining detonation of the fuel/oxidizer mixture, such as to mitigate or eliminate loss of detonation through the detonation chamber may provide an improved operability and/or performance envelope for a heat engine (e.g., heat engine 102, engine 100, aircraft 700, etc.). Improved operability and/or performance envelope may include, but is not limited to, operability of the RDC system 100 at a plurality of portions of a landing-takeoff (LTO) cycle (e.g., taxi, takeoff, climb, cruise, approach, landing, etc.), ground altitude light-off, altitude light-off or re-light, blowout mitigation, or transient performance. Additionally, or alternatively, improved operability and/or performance envelop may include mitigating loss of detonation, including mitigating loss of detonation as a function of changes in fuel and/or oxidizer pressure, flow rate, temperature, or physical property (e.g., viscosity, density, fuel type, etc.). Still further, or alternatively, improved operability and/or performance envelop may include mitigating loss of detonation as a function of changes inlet oxidizer pressure, temperature, or physical property as a function of changes in engine and/or vehicle altitude, speed, or as may correspond to one or more portions of the LTO cycle.

In still yet various embodiments, the method 1000 includes at 1002 injecting, via the first fuel injector, the first fuel/oxidizer mixture into the first portion of the detonation path, and at 1004 injecting, via the second fuel injector, the second fuel/oxidizer mixture into the second portion of the detonation path. In still another embodiment, the method 1000 includes at 1006 detonating, via the predetonation device, the first fuel/oxidizer mixture at the detonation zone, and at 1008 generating the detonation wave at the first portion of the detonation path via first fuel/oxidizer mixture.

In still various embodiments, the method 1000 further includes at 1050 positioning a predetonation device in operative communication with a detonation path at which a detonation zone is determined based at least on the positioning of the predetonation device. In one embodiment, defining the second portion 414 of the detonation path 410 is determined based at least on the positioning of the predetonation device 420. In one embodiment, the method 1000 further includes at 1060 arranging a plurality of first fuel injectors at the first portion of the detonation path, in which the first fuel injector is configured to provide a first fuel/oxidizer mixture to the first portion of detonation path, such as described in regard to FIGS. 1-5. In another embodiment, the method 1000 further includes at 1070 arranging a plurality of second fuel injectors at the second portion of the detonation path, in which the second fuel injector is configured to provide a second fuel/oxidizer mixture to the second portion of the detonation path, such as described in regard to FIGS. 1-5.

It should be appreciated that steps of the method 1000 provided herein may be re-ordered, re-arranged, omitted, altered, or added upon with removing from the scope of the present disclosure. Additionally, or alternatively, steps of the method 1000 provided herein may be stored, implemented or executed as instructions at one or more controllers 210, or portions thereof. The method 1000 outlined in FIG. 6, or steps thereof, may be understood in regard to the exemplary RDC system 100 shown and described in regard to FIGS. 1-5. However, it should be appreciated that certain embodiments of the method 1000 may be performed or executed in other RDC systems not otherwise shown or described herein. It should be appreciated that the method 1000, or steps thereof, may provide unexpected benefits if implemented with an RDC system other than one such as described herein, with benefits such as described herein that were not previously known in the art. For example, arrangements of the first fuel injector configured to produce a lean or leaner burn at a first portion of the detonation path corresponding to approximately 75% to 99% of the detonation path cross-sectional area than the second fuel injector configured to produce a rich or richer burn at a second portion of the detonation path correspond to approximately 25% to 1% of the detonation path cross-sectional area may desirably propagate and/or sustain one or more detonation waves to produce one or more improvements to operability and/or performance such as described herein.

Referring now to FIG. 7, a perspective view of a hypersonic vehicle or hypersonic aircraft 700 in accordance with an exemplary aspect of the present disclosure is provided. The exemplary hypersonic aircraft 700 of FIG. 1 generally defines a vertical direction V, a lateral direction (not labeled), and a longitudinal direction L. Moreover, the hypersonic aircraft 700 extends between a forward end 702 and aft end 704 generally along the longitudinal direction L. For the embodiment shown, the hypersonic aircraft 700 includes a fuselage 706, a first wing 708 extending from a port side of the fuselage 706, and second wing 710 extending from a starboard side of the fuselage 706, and a vertical stabilizer. The hypersonic aircraft 700 includes a propulsion engine or system, which for the embodiment shown includes a pair of hypersonic propulsion systems or engines 712, with a first of such engines 712 mounted beneath the first wing 708 and a second of such engines 712 mounted beneath the second wing 710. The hypersonic propulsion systems 712 may be configured substantially similarly as shown and described in regard to heat engine 102 in regard to FIGS. 1-5, or engine 200 shown and described in regard to FIG. 8. As will be appreciated, the propulsion system may be configured for propelling the hypersonic aircraft 700 from takeoff (e.g., 0 miles per hour up to around 250 miles per hour) up and to hypersonic flight. It will be appreciated, that as used herein, the term “hypersonic” refers generally to air speeds of about Mach 4 up to about Mach 10, such as Mach 5 and up.

Notably, the exemplary hypersonic aircraft 700 depicted in FIG. 1 is provided by way of example only, and in other embodiments may have any other suitable configuration. For example, in other embodiments, the fuselage 706 may have any other suitable shape (such as a more pointed, aerodynamic shape, different stabilizer shapes and orientation, etc.), the propulsion system may have any other suitable engine arrangement (e.g., an engine incorporated into the vertical stabilizer), any other suitable configuration, etc.

Referring now to FIG. 8, a cross-sectional view of a hypersonic propulsion system 200 in accordance with an exemplary aspect of the present disclosure is provided. The engine 200 provided in regard to FIG. 8 is configured substantially similarly as shown and described as the heat engine 102 in regard to FIGS. 1-5. Additionally, or alternatively, the engine 200 is configured to operate substantially similarly to one or more steps of the method 1000 such as outlined and described in regard to FIG. 6. It should be appreciated that various embodiments of the engine 200 shown and described in regard to FIG. 8 may be configured to include the RDC system 100 such as shown and described in regard to FIGS. 1-6. Additionally, or alternatively, the engine 200 includes a rotating detonation combustion system configured to execute instructions such as outlined and described in regard to FIGS. 1-6.

As will be appreciated, the exemplary hypersonic propulsion system 200 depicted generally includes a turbine engine 202 and a ducting assembly 204. FIG. 8 provides a cross-sectional view of an entire length of the turbine engine 202 (showing all of the ducting assembly 204). Notably, the hypersonic propulsion system 200 may be incorporated into a hypersonic aircraft (such as the hypersonic aircraft 700 of FIG. 7 as engine 712).

The exemplary hypersonic propulsion system 200 depicted generally defines an engine inlet 208 at a forward end 211 along the longitudinal direction L and an engine exhaust 213 at an aft end 215 along the longitudinal direction L. Referring to the exemplary turbine engine 202, it will be appreciated that the exemplary turbine engine 202 depicted defines a turbine engine inlet 217, such as may be configured according to the inlet 108 of FIG. 1. The turbine engine 202 further includes a turbine engine exhaust 218. Furthermore, the exemplary turbine engine 202 includes a compressor section, such as may be configured in regard to compressor section 104 of FIG. 1, a combustion section 205, and a turbine section, such as may be configured in regard to turbine section 106 of FIG. 1. The compressor section, the combustion section 205, and the turbine section are each arranged in serial flow order relative to one another. In various embodiments, the combustion section 205 may include embodiments of the RDC system 100 such as shown and described in regard to FIGS. 1-5. Alternatively, the combustion section 205 may include a deflagrative combustion system.

In regard to the turbine engine 202, the compressor section may include a first compressor 220 having a plurality of sequential stages of compressor rotor blades (including a forward-most stage of compressor rotor blades). Similarly, the turbine section includes a first turbine 224, and further includes a second turbine 227. The first turbine 224 is a high speed turbine coupled to the first compressor 220 through a first engine shaft 229. In such a manner, the first turbine 224 may drive the first compressor 220 of the compressor section. The second turbine 227 is a low speed turbine coupled to a second engine shaft 231.

As will also be appreciated, for the embodiment shown, the hypersonic propulsion system 200 further includes a fan 232. The fan 232 is located forward (and upstream) of the turbine engine inlet 217. Moreover, the fan 232 includes a fan shaft 234, which for the embodiment shown is coupled to, or formed integrally with the second engine shaft 231, such that the second turbine 227 of the turbine section of the turbine engine 202 may drive the fan 232 during operation of the hypersonic propulsion system 200. The engine 200 further includes a plurality of outlet guide vanes 233, which for the embodiment depicted are variable outlet guide vanes (configured to pivot about a rotational pitch axis (shown in phantom). The variable outlet guide vanes may further act as struts. Regardless, the variable outlet guide vanes 233 may enable the fan 232 to run at variable speeds and still come out with relatively straight air flow. In other embodiments, the outlet guide vanes 233 may instead be fixed-pitch guide vanes.

Referring still to FIG. 8, the ducting assembly 204 generally includes an outer case 236 and defines a bypass duct 238, the outer case 236 and bypass duct 238 extending around the turbine engine 202. The bypass duct 238 may have a substantially annular shape extending around the turbine engine 202, such as substantially 360 degrees around the turbine engine 202. Additionally, or alternatively, the outer case 236 and/or the bypass duct 238 may define, at least in part, a two-dimensional cross section defining a height and width (e.g., a rectangular cross section). Various embodiments of the outer case 236 and/or the bypass duct 238 may correspond to the RDC system 100, such as depicted in regard to FIG. 4 (e.g., annular) and FIG. 5 (e.g., two-dimensional). It should be appreciated that in various embodiments, the outer case 236 and/or bypass duct 238 may define an annular portion and a two-dimensional portion.

For the embodiment shown in regard to FIG. 8, the bypass duct 238 extends between a bypass duct inlet 240 and a bypass duct exhaust 242. The bypass duct inlet 240 is aligned with the turbine engine inlet 217 for the embodiment shown, and the bypass duct exhaust 242 is aligned with the turbine engine exhaust 218 for the embodiment shown.

Moreover, for the embodiment shown, the ducting assembly 204 further defines an inlet section 244 located at least partially forward of the bypass duct 238 and an afterburning chamber 246 located downstream of the bypass duct 238 and at least partially aft of the turbine engine exhaust 218. Referring particularly to the inlet section 244, for the embodiment shown, the inlet section 244 is located forward of the bypass duct inlet 240 and the turbine engine inlet 217. Moreover, for the embodiment shown, the inlet section 244 extends from the hypersonic propulsion system inlet 208 to the turbine engine inlet 217 and bypass duct inlet 240. By contrast, the afterburning chamber 246 extends from the bypass duct exhaust 242 and turbine engine exhaust 218 to the hypersonic propulsion system exhaust 213 (FIG. 8).

Referring still to FIG. 8, the hypersonic propulsion system 200 depicted may further include an inlet precooler 248 positioned at least partially within the inlet section 244 of the ducting assembly 204 and upstream of the turbine engine inlet 217, the bypass duct 238, or both (and more particularly, upstream of both for the embodiment shown). The inlet precooler 248 is generally provided for cooling an airflow through the inlet section 244 of the ducting assembly 204 to the turbine engine inlet 217, the bypass duct 238, or both.

During operation of the hypersonic propulsion system 200, an inlet airflow is received through the hypersonic propulsion system inlet 208. The inlet airflow passes through the inlet precooler 248, reducing a temperature of the inlet airflow. The inlet airflow then flows into the fan 232. As will be appreciated, the fan 232 generally includes a plurality of fan blades 250 rotatable by the fan shaft 234 (and second engine shaft 231). The rotation of the fan blades 250 of the fan 232 increases a pressure of the inlet airflow. For the embodiment shown, the hypersonic propulsion system 200 further includes at stage of guide vanes 252 located downstream of the plurality of fan blades 250 of the fan 232 and upstream of the turbine engine inlet 217 (and bypass duct inlet 240). For the embodiment shown, the stage of guide vanes 252 is a stage of variable guide vanes, each rotatable about its respective axis. The guide vanes 252 may change a direction of the inlet airflow from the plurality of fan blades 250 of the fan 232. From the stage guide vanes 252, a first portion of the inlet airflow flows through the turbine engine inlet 217 and along a core air flowpath of the turbine engine 202, and a second portion of the inlet airflow flows through the bypass duct 238 of the ducting assembly 204, as will be explained in greater detail below. Briefly, it will be appreciated that the exemplary hypersonic propulsion system 200 includes a forward frame, the forward frame including a forward frame strut 256 (and more specifically a plurality of circumferentially spaced forward frame struts 256) extending through bypass duct 238 proximate the bypass duct inlet 240 and through the core air flowpath of the turbine engine 202 proximate the turbine engine inlet 217.

Generally, the first portion of air passes through the first compressor 220, wherein a temperature and pressure of such first portion of air is increased and provided to the combustion section 205. The combustion section 205 includes a plurality of fuel injectors 128 spaced along the circumferential direction C for providing a mixture of oxidizer, such as compressed air, and a liquid and/or gaseous fuel to a combustion chamber (e.g., detonation chamber 122 of FIGS. 1-5) of the combustion section 205. In various embodiments, the plurality of fuel injectors 128 of the engine 200 are arranged and configured according to one or more embodiments of the plurality of fuel injectors 128 of the RDC system 100 shown and described in regard to FIGS. 1-6. In particular embodiments, the plurality of fuel injectors 128 includes a first fuel injector 228 and a second fuel injector 328 configured to provide a first fuel/oxidizer mixture and a second fuel/oxidizer mixture, respectively, such as shown and described in regard to FIGS. 1-6.

The compressed air and fuel mixture is burned to generate combustion gases, which are provided through the turbine section. The combustion gases are expanded across the first turbine 224 and second turbine 227, driving the first turbine 224 (and first compressor 220 through the first engine shaft 229) and the second turbine 227 (and fan 232 through the second engine shaft 231). The combustion gases are then exhausted through the turbine engine exhaust 218 and provided to the afterburning chamber 246 of the ducting assembly 204.

Referring still to FIG. 8, the second portion of the inlet airflow, as noted above, is provided through the bypass duct 238. Notably, for the embodiment shown, the bypass duct 238 may include a dual stream section, such as to include an inner bypass stream and an outer bypass stream in a parallel flow configuration. Notably, the ducting assembly 204 is designed aerodynamically such that when an outer bypass stream door is in the open position during hypersonic flight operating conditions, a ratio of an amount of airflow through the outer bypass duct stream to an amount of airflow through the inner bypass duct stream is greater than 1:1, such as greater than about 2:1, such as greater than about 4:1, and less than about 100:1, such as less than about 10:1.

Downstream of the dual stream section of the bypass duct 238, the second portion of the inlet airflow is merged back together and flows generally along the longitudinal direction L to the bypass duct exhaust 242. For the embodiment shown, the airflow through the bypass duct 238 is merged with the exhaust gases of the turbine engine 202 at the afterburning chamber 246. The exemplary hypersonic propulsion system 200 depicted includes a bypass airflow door located at the turbine engine exhaust 218 and bypass duct exhaust 242. The bypass airflow door is movable between an open position wherein airflow through the core air flowpath of the turbine engine 202 may flow freely into the afterburning chamber 246, and a closed position (depicted in phantom), wherein airflow from the bypass duct 238 may flow freely into the afterburning chamber 246. Notably, the bypass airflow door 270 may further be movable between various positions therebetween to allow for a desired ratio of airflow from the turbine engine 202 to airflow from the bypass duct 238 into the afterburning chamber 246.

During certain operations, such as during hypersonic flight operations, further thrust may be realized from the airflow into and through the afterburning chamber 246. More specifically, for the embodiment shown, the hypersonic propulsion system 200 further includes an augmenter 272 positioned at least partially within the afterburning chamber 246. Particularly, for the embodiment shown, the augmenter 272 is positioned at an upstream end of the afterburning chamber 246, and more particularly, immediately downstream of the bypass duct exhaust 242 and turbine engine exhaust 218.

Notably, for the embodiment shown, the afterburning chamber 246 is configured as a hyperburner chamber, and the augmenter 272 incorporates a rotating detonation combustor 274, such as embodiments of the RDC system 100 shown and described in regard to FIGS. 1-5. In particular embodiments, the augmenter 272 includes the plurality of fuel injectors 128, including the first fuel injector 228 and the second fuel injector 328, configured such as shown and described in regard to FIGS. 1-6. It should further be appreciated that embodiments of the afterburning chamber 246 may correspond, at least in part, to the detonation chamber 122 configured such as shown and described in regard to FIGS. 1-6.

Further, referring back to FIG. 8, it will be appreciated that the afterburning chamber 246 extends generally to the hypersonic propulsion system exhaust 213, defining a nozzle outlet 282 at the hypersonic propulsion system exhaust 213. Moreover, the afterburning chamber 246 defines an afterburning chamber axial length 284 between the turbine engine exhaust 218 and the hypersonic propulsion system exhaust 213. In various embodiments, the afterburning chamber axial length 284 corresponds to the detonation chamber length 123 of the RDC system 100 shown and described in regard to FIGS. 1-5. In particular embodiments, the hypersonic propulsion system exhaust 213 corresponds to the detonation chamber outlet 126 such as shown and described in regard to FIGS. 1-5. Similarly, the turbine engine 202 defines a turbine engine axial length 286 between the turbine engine inlet 217 and the turbine engine exhaust 218. For the embodiment depicted, the afterburning chamber axial length 284 is at least about fifty percent of the turbine engine axial length 286 and up to about 500 percent of the turbine engine axial length 286. More particularly, for the embodiment shown, the afterburning chamber axial length 284 is greater than the turbine engine axial length 286. For example, in certain embodiments, the afterburning chamber 246 may define an afterburning chamber axial length 284 that is at least about 125 percent of the turbine engine axial length 286, such as at least about 150 percent of the turbine engine 202. However, in other embodiments (such as embodiments incorporating the rotating detonation combustor 274), the afterburning chamber axial length 284 may be less than the turbine engine axial length 286.

Moreover, it will be appreciated that in at least certain exemplary embodiments, the hypersonic propulsion system 200 may include one or more components for varying a cross-sectional area of the nozzle outlet 282. As such, the nozzle outlet 282 may be a variable geometry nozzle outlet configured to change in cross-sectional area based on e.g., one or more flight operations, ambient conditions, or operating modes of the RDC system 100 (e.g., to sustain rotating detonation of the fuel/oxidizer mixture), etc.

For the embodiment shown, it will be appreciated that the exemplary hypersonic propulsion system 200 further includes a fuel delivery system 288. The fuel delivery system 288 is configured for providing a flow fuel to the combustion section 205 of the turbine engine 202, and for the embodiment shown, the augmenter 272 positioned at least partially within the afterburning chamber 246. Embodiments of the engine 200 include the controller 210 such as shown and described in regard to FIGS. 1-5, and further configured to store and/or execute one or more steps of the method 1000 outlined in regard to FIG. 6. The exemplary fuel delivery system 288 depicted generally includes a fuel tank 290 and a fuel oxygen reduction unit 292. The fuel oxygen reduction unit 292 may be configured to reduce an oxygen content of the fuel flow from the fuel tank 290 and through the fuel delivery system 288.

The fuel delivery system 288 further includes a fuel pump 294 configured to increase a pressure of the fuel flow through the fuel delivery system 288. Further, for the embodiment shown the inlet precooler 248 is a fuel-air heat exchanger thermally coupled to the fuel delivery system 288. More specifically, for the embodiment shown, the inlet precooler 248 is configured to utilize fuel directly as a heat exchange fluid, such that heat extracted from the inlet airflow through the inlet section 244 of the ducting assembly 204 is transferred to the fuel flow through the fuel delivery system 288. For the embodiment shown, the heated fuel (which may increase in temperature by an amount corresponding to an amount that the inlet airflow temperature is reduced by the inlet precooler 248, as discussed above) is then provided to the combustion section 205 and/or the augmenter 272. Notably, in addition to acting as a relatively efficient heat sink, increasing a temperature of the fuel prior to combustion may further increase an efficiency of the hypersonic propulsion system 200.

In various embodiments, the fuel delivery system 288 is in operable communication with the controller 210 to receive and/or send data, instructions, or feedback between one another. The fuel delivery system 288, the controller 210, and the RDC system 100, such as positioned at the combustion section 202 and/or the afterburning chamber 236, may be in communication and operably coupled to one another. In particular embodiments, the fuel delivery system 288 is configured to provide flow rates, pressures, temperatures, densities, or other fuel flow characteristics to flows of fuel corresponding to the first fuel/oxidizer mixture at the first fuel injector 228 and the second fuel/oxidizer mixture at the second fuel injector 328 such as described herein. The fuel delivery system 288 may further be in operable communication with the controller 210 to provide respective flows of liquid and/or gaseous fuel to the RDC system 100 (FIGS. 1-5), such as may be positioned at the combustion section 202 and/or the afterburning chamber 236. In particular embodiments, the fuel delivery system 288 may provide flows of fuel in thermal communication with the inlet precooler 248 based, at least in part, on a desired fuel characteristic corresponding to sustaining the detonation wave 130 (FIGS. 3A-3B) via the richer burn of the second fuel/oxidizer mixture flowed from the second fuel injector 328 at the second portion 414 of the detonation path 410 (FIGS. 4-5) in contrast to the leaner burn of the first fuel/oxidizer mixture flowed from the first fuel injector 228 at the first portion 412 of the detonation path 410 (FIGS. 4-5).

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

Further aspects of the invention are provided by the subject matter of the following clauses:

1. A method for operating a rotating detonation combustion assembly, the method including generating a first fuel/oxidizer equivalence ratio of detonation gases at a first portion of a detonation path, in which the first portion of the detonation path is defined along a first direction from the detonation zone along which a detonation wave propagates. The method further including generating a second fuel/oxidizer equivalence ratio of detonation gases at the second portion of the detonation path, in which the second fuel/oxidizer equivalence ratio is different from the first fuel/oxidizer equivalence ratio, and wherein the second portion of the detonation path is defined between the first portion and the predetonation device. The method further including sustaining the detonation wave via the second fuel/oxidizer equivalence ratio of detonation gases at the second portion of the detonation path.

2. The method of any preceding clause, wherein the first fuel/oxidizer equivalence ratio of detonation gases defines a lower equivalence ratio than the second fuel/oxidizer equivalence ratio of detonation gases.

3. The method of any preceding clause, wherein generating the second fuel/oxidizer equivalence ratio of detonation gases corresponds to rich burn of the second fuel/oxidizer mixture.

4. The method of any preceding clause, wherein generating the first fuel/oxidizer equivalence ratio of detonation gases correspond to lean burn of the first fuel/oxidizer mixture.

5. The method of any preceding clause, the method further including injecting a first fuel/oxidizer mixture into the first portion of the detonation path, the first fuel/oxidizer mixture corresponding to generating the first fuel/oxidizer equivalence ratio, and injecting a second fuel/oxidizer mixture into the second portion of the detonation path, the second fuel/oxidizer mixture corresponding to generating the second fuel/oxidizer equivalence ratio

6. The method of any preceding clause, wherein generating the first fuel/oxidizer equivalence ratio of detonation gases at a first portion of the detonation path includes detonating a first fuel/oxidizer mixture at the detonation zone, and generating the detonation wave at the first portion of the detonation path.

7. The method of any preceding clause, wherein sustaining the detonation wave comprises sustaining the detonation wave via a second fuel/oxidizer mixture corresponding to a richer burn of the second fuel/oxidizer mixture relative to the first fuel/oxidizer mixture.

8. The method of any preceding clause, wherein generating the second fuel/oxidizer equivalence ratio of detonation gases at the second portion of the detonation path corresponds to generating the second fuel/oxidizer equivalence ratio of detonation gases between 1% and 25% of the detonation path.

9. The method of any preceding clause, further including positioning a predetonation device in operative communication with a detonation path at which a detonation zone is determined based at least on the positioning of the predetonation device, arranging a plurality of first fuel injectors at the first portion of the detonation path, wherein the first fuel injector is configured to provide a first fuel/oxidizer mixture to the first portion of detonation path, and arranging a plurality of second fuel injectors at the second portion of the detonation path, wherein the second fuel injector is configured to provide a second fuel/oxidizer mixture to the second portion of the detonation path.

10. The method of any preceding clause, wherein arranging the plurality of first fuel injectors comprises arranging the plurality of first fuel injectors in sequential arrangement along the first direction from the predetonation device, and further wherein arranging the plurality of second fuel injectors comprises arranging the plurality of second fuel injectors in sequential arrangement along the first direction from the plurality of first fuel nozzles to the predetonation device.

11. A rotating detonation combustion assembly including a detonation chamber extended around a centerline axis, wherein the detonation chamber defines a detonation path, and wherein the rotating detonation combustion assembly includes a predetonation device extended to the detonation chamber in operative communication with a fuel/oxidizer mixture at the detonation chamber, wherein the predetonation device defines a detonation zone at the detonation path at which the predetonation device generates a detonation wave of the fuel/oxidizer mixture at the detonation chamber, and wherein a first portion of the detonation path is defined along a first direction from the detonation zone along which the detonation wave propagates, and further wherein a second portion of the detonation path different from the first portion of the detonation path is defined along a second direction opposite of the first direction between the predetonation device and the first portion of the detonation path. The rotating detonation combustion assembly further includes a plurality of fuel injectors positioned in adjacent arrangement around a centerline axis, wherein the plurality of fuel injectors is in fluid communication with the detonation path. The plurality of fuel injectors includes a first fuel injector configured to generate a first fuel/oxidizer mixture at the first portion of the detonation path, and a second fuel injector configured to generate a second fuel/oxidizer mixture at the second portion of the detonation path, wherein the second fuel/oxidizer mixture is different from the first fuel/oxidizer mixture.

12. The rotating detonation combustion assembly of any preceding clause, wherein the second portion of the detonation path corresponds to between 1% and 25% of the detonation path.

13. The rotating detonation combustion assembly of any preceding clause, wherein the first fuel injector comprises one or more of a cross sectional area or volume different from the second fuel injector.

14. The rotating detonation combustion assembly of any preceding clause, wherein the first fuel injector defines a lower equivalence ratio burn fuel injector than the second fuel injector defining a richer burning fuel injector than the first fuel injector.

15. A propulsion system for a hypersonic vehicle, the propulsion system including a rotating detonation combustion assembly, the rotating detonation combustion assembly including a detonation chamber extended around a centerline axis, wherein the detonation chamber defines a detonation path, and wherein the rotating detonation combustion assembly includes a predetonation device extended to the detonation chamber, wherein the predetonation device defines a detonation zone at the detonation path at which the predetonation device generates a detonation wave of detonation gases at the detonation chamber, and wherein a first portion of the detonation path is defined along a first direction from the detonation zone along which the detonation wave propagates, and further wherein a second portion of the detonation path different from the first portion of the detonation path is defined along the first direction from the first portion of the detonation path to the predetonation device. The rotating detonation combustion assembly further including a plurality of fuel injectors positioned in adjacent arrangement around a centerline axis, wherein the plurality of fuel injectors is in fluid communication with the detonation path. The plurality of fuel injectors includes a first fuel injector configured to generate a first fuel/oxidizer mixture at the first portion of the detonation path, and a second fuel injector configured to generate a second fuel/oxidizer mixture at the second portion of the detonation path, wherein the second fuel/oxidizer mixture is different from the first fuel/oxidizer mixture. The propulsion system further includes a controller configured to execute instructions, the instructions including generating, via the first fuel/oxidizer mixture, a first fuel/oxidizer equivalence ratio of detonation gases at the first portion of the detonation path, and generating, via the second fuel/oxidizer mixture, a second fuel/oxidizer equivalence ratio of detonation gases at the second portion of the detonation path, wherein the second fuel/oxidizer equivalence ratio is different from the first fuel/oxidizer equivalence ratio.

16. The propulsion system of any preceding clause, wherein the first fuel/oxidizer equivalence ratio of detonation gases defines a lower equivalence ratio than the second fuel/oxidizer equivalence ratio of detonation gases.

17. The propulsion system of any preceding clause, wherein generating the second fuel/oxidizer equivalence ratio of detonation gases corresponds to rich burn of the second fuel/oxidizer mixture relative to the first fuel/oxidizer mixture.

18. The propulsion system of any preceding clause, the instructions further including injecting, via the first fuel injector, the first fuel/oxidizer mixture into the first portion of the detonation path, and injecting, via the second fuel injector, the second fuel/oxidizer mixture into the second portion of the detonation path.

19. The propulsion system of any preceding clause, the instructions further comprising detonating, via the predetonation device, the first fuel/oxidizer mixture at the detonation zone, and generating the detonation wave at the first portion of the detonation path via first fuel/oxidizer mixture.

20. The propulsion system of any preceding clause, the instructions further comprising sustaining the detonation wave via the second fuel/oxidizer mixture corresponding to a richer burn of the second fuel/oxidizer mixture at the second portion of the detonation path relative to the first fuel/oxidizer mixture.

21. The propulsion system of any preceding clause, further comprising a combustion section, a ducting assembly defining an afterburning chamber, and an augmenter positioned at least partially within the afterburning chamber, wherein the rotating detonation combustion system is positioned at one or more of the augmenter or the combustion section.

22. The propulsion system of any preceding clause comprising the rotating detonation combustion assembly of any preceding clause.

23. The propulsion system of any preceding clause configured to execute one or more steps of the method of any preceding clause for operating a rotating detonation combustion assembly.

24. The propulsion system of any preceding clause comprising a controller configured to execute instructions, the instructions including one or more steps of the method of any preceding clause for operating a rotating detonation combustion assembly of any preceding clause.

What is claimed is:

1. A method for operating a rotating detonation combustion assembly, the method comprising:
generating a first fuel/oxidizer equivalence ratio of detonation gases at a first portion of a detonation path, wherein the first portion of the detonation path is defined along a first direction from a detonation zone along which a detonation wave propagates;
generating a second fuel/oxidizer equivalence ratio of detonation gases at the second portion of the detonation path, wherein the second fuel/oxidizer equivalence ratio is different from the first fuel/oxidizer equivalence ratio, and wherein the second portion of the detonation path is defined between the first portion and the predetonation device; and
sustaining the detonation wave via the second fuel/oxidizer equivalence ratio of detonation gases at the second portion of the detonation path.

2. The method of claim 1, wherein the first fuel/oxidizer equivalence ratio of detonation gases comprises a lower equivalence ratio than the second fuel/oxidizer equivalence ratio of detonation gases.

3. The method of claim 2, wherein generating the second fuel/oxidizer equivalence ratio of detonation gases corresponds to rich burn of the second fuel/oxidizer mixture.

4. The method of claim 2, wherein generating the first fuel/oxidizer equivalence ratio of detonation gases corresponds to lean burn of the first fuel/oxidizer mixture.

5. The method of claim 1, further comprising:
injecting a first fuel/oxidizer mixture into the first portion of the detonation path, the first fuel/oxidizer mixture corresponding to generating the first fuel/oxidizer equivalence ratio; and
injecting a second fuel/oxidizer mixture into the second portion of the detonation path, the second fuel/oxidizer mixture corresponding to generating the second fuel/oxidizer equivalence ratio.

6. The method of claim 1, wherein generating the first fuel/oxidizer equivalence ratio of detonation gases at a first portion of the detonation path comprises:
detonating a first fuel/oxidizer mixture at the detonation zone; and
generating the detonation wave at the first portion of the detonation path.

7. The method of claim 6, wherein sustaining the detonation wave comprises sustaining the detonation wave via a second fuel/oxidizer mixture corresponding to a richer burn of the second fuel/oxidizer mixture than the first fuel/oxidizer mixture.

8. The method of claim 1, wherein generating the second fuel/oxidizer equivalence ratio of detonation gases at the second portion of the detonation path corresponds to generating the second fuel/oxidizer equivalence ratio of detonation gases between 1% and 25% of the detonation path.

9. The method of claim 1, further comprising:
positioning a predetonation device in operative communication with the detonation path, wherein the detonation zone is determined based at least on the positioning of the predetonation device;
arranging a plurality of first fuel injectors at the first portion of the detonation path, wherein the first fuel injector is configured to provide a first fuel/oxidizer mixture to the first portion of detonation path; and
arranging a plurality of second fuel injectors at the second portion of the detonation path, wherein the second fuel injector is configured to provide a second fuel/oxidizer mixture to the second portion of the detonation path.

10. The method of claim 9, wherein arranging the plurality of first fuel injectors comprises arranging the plurality of first fuel injectors in sequential arrangement along the first direction from the predetonation device, and further wherein arranging the plurality of second fuel injectors comprises arranging the plurality of second fuel injectors in sequential arrangement along the first direction from the plurality of first fuel nozzles to the predetonation device.

11. A rotating detonation combustion assembly, the rotating detonation combustion assembly comprising:
a chamber extended around a centerline axis, wherein the chamber defines a detonation path;
a predetonation device extended to the chamber in operative communication with a fuel/oxidizer mixture at the chamber, wherein the predetonation device defines a detonation zone at the detonation path at which the predetonation device generates a detonation wave of the fuel/oxidizer mixture at the detonation chamber, and wherein a first portion of the detonation path is defined along a first direction from the detonation zone along which the detonation wave propagates, and further wherein a second portion of the detonation path is defined along a second direction opposite of the first direction between the predetonation device and the first portion of the detonation path; and
a plurality of fuel injectors positioned in adjacent arrangement around a centerline axis, wherein the plurality of fuel injectors is in fluid communication with the detonation path, and further wherein the plurality of fuel injectors comprises:
a first fuel injector configured to generate a first fuel/oxidizer mixture at the first portion of the detonation path; and
a second fuel injector configured to generate a second fuel/oxidizer mixture at the second portion of the detonation path, wherein the second fuel/oxidizer mixture is different from the first fuel/oxidizer mixture.

12. The rotating detonation combustion assembly of claim 11, wherein the second portion of the detonation path corresponds to between 1% and 25% of the detonation path.

13. The rotating detonation combustion assembly of claim 11, wherein the first fuel injector defines a lower equivalence ratio burn fuel injector than the second fuel injector defining a richer burning fuel injector relative to the first fuel injector.

14. A propulsion system for a hypersonic vehicle, the propulsion system comprising:
a rotating detonation combustion assembly comprising:
a chamber extended around a centerline axis, wherein the chamber defines a detonation path;
a predetonation device extended to the chamber, wherein the predetonation device defines a detonation zone at the detonation path at which the predetonation device generates a detonation wave of gases at the chamber, and wherein a first portion of the detonation path is defined along a first direction from the detonation zone along which the detonation wave propagates, and further wherein a second portion of the detonation path is defined along the first direction from the first portion of the detonation path to the predetonation device; and
a plurality of fuel injectors positioned in adjacent arrangement around a centerline axis, wherein the plurality of fuel injectors is in fluid communication with the detonation path, and further wherein the plurality of fuel injectors comprises:
a first fuel injector configured to generate a first fuel/oxidizer mixture at the first portion of the detonation path; and
a second fuel injector configured to generate a second fuel/oxidizer mixture at the second portion of the detonation path, wherein the second fuel/oxidizer mixture is different from the first fuel/oxidizer mixture; and
a controller configured to execute instructions, the instructions comprising:
generating, via the first fuel/oxidizer mixture, a first fuel/oxidizer equivalence ratio of detonation gases at the first portion of the detonation path; and
generating, via the second fuel/oxidizer mixture, a second fuel/oxidizer equivalence ratio of detonation gases at the second portion of the detonation path, wherein the second fuel/oxidizer equivalence ratio is different from the first fuel/oxidizer equivalence ratio.

15. The propulsion system of claim 14, wherein the first fuel/oxidizer equivalence ratio of detonation gases comprises a lower equivalence ratio than the second fuel/oxidizer equivalence ratio of detonation gases.

16. The propulsion system of claim 15, wherein generating the second fuel/oxidizer equivalence ratio of detonation gases corresponds to rich burn of the second fuel/oxidizer mixture relative to the first fuel/oxidizer mixture.

17. The propulsion system of claim 14, the instructions further comprising:
injecting, via the first fuel injector, the first fuel/oxidizer mixture into the first portion of the detonation path; and
injecting, via the second fuel injector, the second fuel/oxidizer mixture into the second portion of the detonation path.

18. The propulsion system of claim 14, the instructions further comprising:
detonating, via the predetonation device, the first fuel/oxidizer mixture at the detonation zone; and
generating the detonation wave at the first portion of the detonation path via first fuel/oxidizer mixture.

19. The propulsion system of claim 18, the instructions further comprising:
sustaining the detonation wave via the second fuel/oxidizer mixture corresponding to a richer burn of the second fuel/oxidizer mixture at the second portion of the detonation path relative to the first fuel/oxidizer mixture.

20. The propulsion system of claim 14, further comprising:
a combustion section;
a ducting assembly defining an afterburning chamber; and
an augmenter positioned at least partially within the afterburning chamber, wherein the rotating detonation combustion system is positioned at one or more of the augmenter or the combustion section.
